(19) United States
(12) Patent Application Publication
(10) Pub. No.: US 2010/0288736 A1
(43) Pub. Date: Nov. 18, 2010

(54) WELD STUD

(75) Inventor: Daisuke MIURA, Toyohashi-shi (JP)

Correspondence Address: THE BLACK & DECKER CORPORATION, 701 EAST JOPPA ROAD, TW199, TOWSON, MD, 21286, US

(73) Assignee: NEWFREY LLC, Newark, DE (US)

(21) Appl. No.: 12/819,704

(22) Filed: Jun. 21, 2010

(30) Foreign Application Priority Data
Dec. 21, 2007 (JP) 2007-329793
Dec. 18, 2008 (US) PCT/US2008/087321

(51) Int. Cl. B23K 11/04; F16B 37/06

(52) U.S. Cl. 219/99; 411/171

(57) ABSTRACT

A weld stud 10 comprises a weld flange adapted to be welded to a workpiece and a portion integrally formed with the weld flange. The flange has a surface to be welded. The surface includes a flattened annular portion of a predetermined radial width at an outer periphery thereof and a conical recess conically formed from the annular portion to the center thereof, so that only the annular portion is welded to the workpiece.

### CROSS-REFERENCE TO RELATED APPLICATIONS

This application claims the benefit of PCT/US08/87321, filed Dec. 18, 2008 and Japanese Patent Application No. 2007-329793, filed on Dec. 21, 2007, the disclosure of which is incorporated herein by reference.

### TECHNICAL FIELD

This invention relates to a weld stud, and more particularly to a weld stud suitable for welding to a thin panel.

### BACKGROUND TECHNOLOGY

Weld flanges welded to members being welded to and weld studs having parts formed integrally with weld flanges are described, for example, in Patent Literature 1 (TOKKAI [Unexamined Patent Application Publication] No. S63-313675/1988, Gazette).

Patent Literature 1: TOKKAI No. S63-313675/1988, Gazette

Patent Literature 2: PCT (WO) 2006-502359, Gazette (International KOKAI No. 2004/033923)

Patent Literature 3: JIKKA| [Unexamined Util. Mod. Application Publication] No. H6-066872/1994, Gazette

Patent Literature 4: TOKKAI No. S56-134612/1981, Gazette (UK Patent Application KOKAI [Unexamined Patent Application Publication] No. 206501, Specification)

Patent Literature 5: U.S. Pat. No. 3,671,710, Specification

With the known weld stud described in Patent Literature 1, for example, the welding arcs/electrical discharge arcs are concentrated in the center part of the weld flange whereupon, when the member being welded to is a thin panel, that portion being welded becomes thin and the strength thereof deteriorates, and furthermore, in the worst cases, there is a danger of a hole opening in that portion. This is described with reference to FIGS. 1(A) and 1(B). In FIG. 1(A), in the weld flange 2 of a weld stud 1 at the center of the weld surface, a circular weld part 3 is formed, protruding from the other parts of the weld flange 2. When the weld stud 1 having the weld flange 2 so configured is welded to a member being welded to 5, the arcs 6 as indicated by the symbol 6 are generated so as to be concentrated at the weld part 3 and the portion of the member being welded to 5 at the lower surface of that weld part 3. Due to the concentration of the arcs 6, portions of the member being welded to 5 are fused also and not just the weld part 3. As a consequence, as diagrammed in FIG. 1(B), the thickness of the welded portion 7 of the member being welded to 5 is reduced, and strength deteriorates. When the member being welded to is a thin panel, there is a danger of a hole opening in that welded portion 7.

With the weld studs described in Patent Literature 2 and 3, the surface on the side of the weld flange being welded is formed in a weld ring shape at the outer edge thereof and a round concavity is formed in the center portion. With such a weld stud as this, forming the ring-shaped weld portion in the weld flange is time-consuming, and the weld stud becomes expensive.

With the weld stud described in Patent Literature 4, a weld ring shape is formed that protrudes from the other portions slightly to the inside from the outer edge of the surface on the side of the weld flange being welded, and a round concavity is formed in the center portion. With such a weld stud as this, also, forming the ring-shaped weld portion in the weld flange is time-consuming, and the weld stud becomes expensive. With the weld stud described in Patent Literature 5, there is no weld flange, and a spherical concavity is formed in a weld end surface of a rod-shaped weld portion. With such a weld stud as this, the surface area of the portion contacting the weld end surface is small, whereupon lengthy weld times are required to obtain satisfactory weld strength, and when the member being welded to is a thin panel, there is a danger of a hole opening.

Accordingly, an aspect of the present invention is to provide a weld stud wherewith proper welding can be done even when a thin panel is the member being welded to.

### BRIEF DESCRIPTION OF THE DRAWINGS

FIG. 1 diagrams how a known weld stud is welded to a member being welded to, with 1(A) being a section diagramming the condition during welding and 1(B) being a section diagramming the condition after welding.

FIG. 2 is a front elevation of a weld stud relating to one embodiment of the present invention.

FIG. 3 diagrams how the weld stud diagrammed in FIG. 2 is welded to a member being welded to, with 3(A) being a section diagramming the condition during welding and 3(B) being a section diagramming the condition after welding.

### DISCLOSURE OF THE INVENTION

In order to realize the object stated above, based on the present invention, a weld stud is provided, having a weld flange to be welded to a member being welded to, and a portion formed integrally with the weld flange wherein, in the weld flange, the outer edge of the surface on the side to be welded is formed flat by a ring-shaped part of a certain width, and a round conical recess is provided, formed in a round conical shape from the ring-shaped part toward the center, whereupon only the ring-shaped part is welded to the above-described member being welded to.

By the configuration described above, welding arcs cease to be concentrated in the center, and, even when a thin panel is the member being welded to, the welded portion of the member being welded to becoming thin, or a hole opening therein, is prevented. Moreover, because no welding arc is generated there, the center portion of the weld flange is maintained at high strength, and in cases where there is a portion in the center portion of the weld flange where a bolt or the like is integrally formed, the high strength of that portion is maintained.

In the weld stud described in the foregoing, the inclination angle in the conical recess should preferably be 12 to 13 degrees. It is further preferable that the weld flange be formed in a round plate shape with an outer diameter of 13 mm and a thickness of 2 mm; that the diameter of the portion adjacent to the ring-shaped part of the conical recess be 10 mm; and that the apex of the conical recess be at a height of 1.2 mm from the weld surface of the ring-shaped part. The portion formed integrally with the weld flange can be made a bolt that rises from the center of the weld flange. That bolt can have M6 (6 mm) treads, for example.

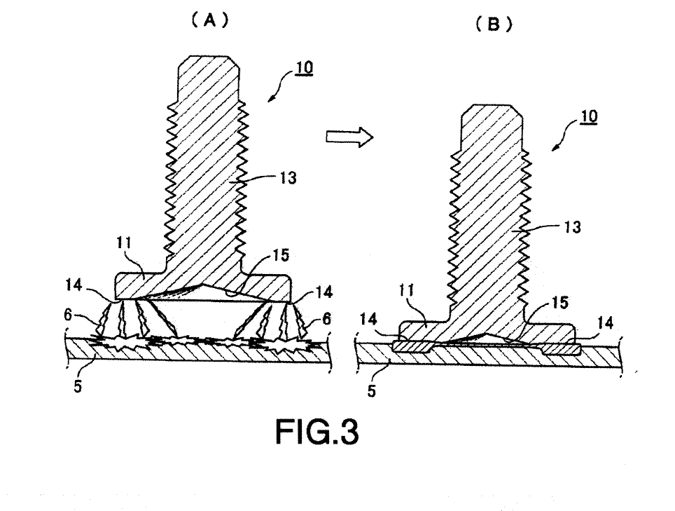

A weld stud 10 relating to one exemplary embodiment of the present invention is now described with reference to FIG. 2, FIG. 3(A), and FIG. 3(B). The weld stud 10 has a weld flange 11 that provides a weld surface that is to be welded to a panel or other member being welded to, and a bolt 13 that is to be attached to another attaching member and constituting a portion formed integrally with the weld flange. The bolt 13 may be formed in some other shape. The bolt 13 portion, for example, may be formed as an I-shaped stud, shaped as an I-shaped rod-like part comprising a shaft of a certain height and a head at its end. At least the weld flange 11 portion of the weld stud 10 is to be formed of a metallic material wherewith stud welding is possible.

The weld flange 11 is formed overall in a round plate shape that is not thick, of a certain thickness T and diameter D1. The outer edge of the surface of the weld flange 11 on the weld side is formed as a ring-shaped part 14 of a certain width, the surface of which ring-shaped part 14 is formed flat so as to be weldable. On the weld surface side of the weld flange 11, the portion inside from the ring-shaped part 14 is formed as a conical recess 15 that is conical toward the center. For that reason, of the surface on the weld side of the weld flange 11, only the ring-shaped part 14 will be welded to the member being welded to. The bolt 13 is formed so as to rise from the center of the weld flange 11, that is, from the portion where the conical recess 15 is formed.

By being formed as described above in the weld flange 11, only the ring-shaped part 14 will be welded to the member being welded to, whereupon area strength will be enhanced, and welding at the center part of the weld flange 11 will not be effected due to the conical recess 15 at that center part; therefore it will be possible to perform the weld while suppressing the thermal effects of the arc heat on the base material to a minimum by welding only the outer edge, avoiding the center. Further description is now given with reference to FIG. 3(A) and FIG. 3(B). In FIG. 3(A), when an electrical current is passed through the weld stud 10 and welding arcs 6 are generated between the weld flange 11 and the member being welded to 5, such arcs 6 are not readily generated at the conical recess 15 portion, but rather most of the welding arcs 6 are generated only at the ring-shaped part 14 portion, whereupon the portion that is the member being welded to 5 and the ring-shaped part 14 are fused at those arc portions. Consequently, as diagrammed in FIG. 3(B), welding will be effected at the ring-shaped part 14 portion, while at the conical recess 15 portion and also in the member being welded to 5 portion, there will be substantially no effects of melting. Accordingly, the welding arcs will not be concentrated in the center, and even when a thin panel is the member being welded to, the welded portion of the member being welded to becoming thin, or a hole opening therein, will be prevented.

In the embodiment diagrammed in the drawings, the inclination angle α of the conical recess 15 is 12 to 13 degrees. The diameter D1 of the weld flange is 13 mm, while the thickness T thereof is 2 mm. In the conical recess 15, the diameter D2 of the portion adjacent the ring-shaped part 14 is 10 mm, while the apex of the conical recess 15, that is the center thereof, is at a height of 1.2 mm from the weld surface of the ring-shaped part 14. Withen the angle α of the conical recess 15 at 12 to 13 degrees, there is almost no generation of welding arcs at the conical recess 15 portion during welding, and welding could be performed in good order at the ring-shaped part 14 on the outer edge side only. Even when the thickness of the weld flange 11 is 2 mm, almost no arcs are generated at the root portion of the bolt 13 due to the conical recess 15, and it becomes possible to effect design such that high strength is secured in the root portion of the bolt 13. Hence, it becomes possible to effect design with the same dimensions as in studs having flanges with outer diameters of 13 mm as are used currently, providing the advantage of being able to interchange them without the necessity of altering the design of the member being welded to. Needless to say, in terms of other equipment as well, such weld studs can be used without any modification of current equipment.

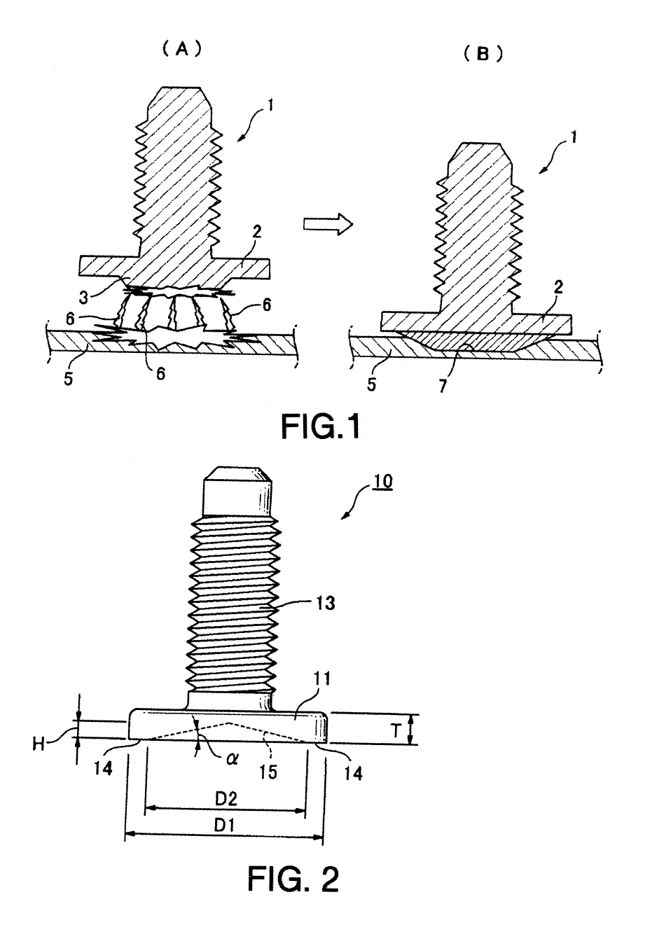

For comparison purposes, the known weld stud 1 diagrammed in FIG. 1, with the outer diameter of the weld flange 2 thereof at 13 mm, was welded to a member being welded to 5 that is a thin panel. When that was done, the diameter of the weld surface of the member being welded to 5 became 9 mm from the center, the weld portion became even thinner with members being welded to having a thickness of 0.7 mm or less, and when another member was combined with the bolt, the weld stud 1 pulled away from the member being welded to 5. The reason for this is thought to be that, in the case of the weld flange 2, because welding was done by generating arcs with a diameter of 9 mm from the center part, fusion and degradation occurred in the member being welded to due to the heat generated during welding, whereupon the post-welding strength of the weld declined due to a reduction of the plate thickness.

For the portion formed integrally with the weld flange 11, the bolt 13 that rises from the center of the weld flange 11 can be made one having M6 (6 mm) threads, for example.

Although exemplary embodiments of the present invention have been shown and described, it will be appreciated by those skilled in the art that changes may be made to these embodiments without departing from the principles and spirit of the invention, the scope of which is defined in the appended claims and their equivalents.

What is claimed is:

1. A weld stud comprising:
a weld flange comprising a first surface and a second surface opposite the first surface;
a bolt projecting from the first surface of the weld flange;
a conical recess on the second surface of the weld flange;
wherein the weld flange has a diameter of D1 and the conical recess has a diameter of D2, and wherein D2 is less than D1.

2. A weld stud according to claim 1, wherein an angle of inclination of the conical recess is 12 to 13 degrees.

3. A weld stud according to claim 1, wherein an apex of the conical recess is at a central axis of the weld stud.

4. A weld stud according to claim 1, wherein a depth of the recess is greater than 50% of the thickness of the weld flange.

5. A weld stud according to claim 1, wherein the weld flange is substantially round.

6. A weld stud assembly comprising:
a weld stud; and
a member to which the weld stud is welded;
wherein the weld stud comprises a weld flange and a bolt extending from a first side of the weld flange;
wherein the weld stud further comprises a conical recess on a second side of the weld flange facing the member to which the weld stud is welded;
wherein a conical recess is formed on a central portion of the second side of the weld flange;
wherein the weld flange has a ring shaped portion outside the conical recess; and
wherein weld stud is welded to the member to which the weld stud is welded at the ring shaped portion.

7. The weld stud assembly of claim 6 wherein an angle of inclination of the conical recess is 12 to 13 degrees.

8. The weld stud assembly of claim 6 wherein an apex of the conical recess is at a central axis of the weld stud.

9. The weld stud assembly of claim 6 wherein a depth of the recess is greater than 50% of the thickness of the weld flange.

10. The weld stud assembly of claim 6 wherein the weld flange is substantially round.

11. A method of welding a weld stud to a member, comprising:
providing a member;
providing a weld stud, the weld stud comprising a weld flange and a bolt extending from a first side of the weld flange, the weld stud further comprising a conical recess on a second side of the weld flange facing the member to which the weld stud is welded, wherein a conical recess is formed on a central portion of the second side of the weld flange, wherein the weld flange has a ring shaped portion outside the conical recess;
passing an electrical current through the weld stud such that welding arcs are generated between the weld flange and the member mostly at the ring shaped portion; and
fusing the weld stud and the member.

12. The method of claim 11, wherein an angle of inclination of the conical recess is 12 to 13 degrees.

13. The method of claim 11, wherein an apex of the conical recess is at a central axis of the weld stud.

14. The method of claim 11, wherein a depth of the recess is greater than 50% of the thickness of the weld flange.

15. The method of claim 11, wherein the weld flange is substantially round.
